(19) United States
(12) Patent Application Publication
(10) Pub. No.: US 2014/0219236 A1
(43) Pub. Date: Aug. 7, 2014

(54) BASE STATION AND COMMUNICATION CONTROL METHOD

(71) Applicants: Tooru Uchino, Tokyo (JP); Anil Umesh, Tokyo (JP)

(72) Inventors: Tooru Uchino, Tokyo (JP); Anil Umesh, Tokyo (JP)

(73) Assignee: NTT DOCOMO, INC., Tokyo (JP)

(21) Appl. No.: 14/346,088

(22) PCT Filed: Oct. 2, 2012
(86) PCT No.: PCT/JP2012/075552

§ 371 Date: Mar. 20, 2014

(30) Foreign Application Priority Data
Oct. 6, 2011 (JP) 2011-222034

(51) Int. Cl. H04L 5/00

(52) U.S. Cl. CPC H04L 5/0037
USPC 370/329

(57) ABSTRACT

A base station 100 estimates the amount of buffered data in a mobile station buffer, which is included in a mobile station 200A and configured to temporarily store downlink data and uplink data, on the basis of a sum of: downlink data which has been transmitted to the mobile station 200A already but whose acknowledgement has not been received yet; and uplink data which is presumed to be transmitted from the mobile station 200A to the base station 100 after transmission of acknowledgement of uplink data from the base station 100 to the mobile station 200A. The base station 100 stops scheduling of at least one of downlink data to be transmitted to the mobile station 200A and uplink data to be transmitted from the mobile station if the estimated amount of buffered data exceeds a predetermined threshold.

### TECHNICAL FIELD

The present invention relates to a base station including a layer 2 buffer which is a second layer level buffer configured to temporarily store data to be transmitted to a mobile station, and relates to a communication control method.

### BACKGROUND ART

In Long Term Evolution (LTE) which is standardized by the 3rd Generation Partnership Project (3GPP), a base station (eNB) is provided with a buffer of layer 2 level (RLC/PDCP) (hereinafter layer 2 buffer) configured to temporarily store data (IP packets) to be transmitted to a mobile station (UE). Data stored in the layer 2 buffer is transmitted to the mobile station, and is discarded from the buffer upon acknowledgement through ACK in the RLC layer that the mobile station has received the data normally.

The layer 2 buffer is shared by multiple mobile stations located within a cell formed by the base station. In addition, each mobile station is also provided with a layer 2 buffer which is shared by one or multiple radio access bearers and configured to temporarily store downlink (DL) data transmitted from the base station and uplink (UL) data to be transmitted to the base station.

### PRIOR ART DOCUMENT

### Non-Patent Document

Non-patent Document 1: 3GPP TS36.300 V10.3.0, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10), March, 2011.

### SUMMARY OF THE INVENTION

However, a method of controlling the conventional layer 2 buffers described above has the following problem. Specifically, when the quality of uplink and downlink between the base station and each mobile station is good, the effective communication speed is so high that a large amount of data arrives at the mobile station in a short period (or a large amount of uplink transmission data is left buffered). Accordingly, an overflow of the layer 2 buffer of the mobile station is likely to occur.

The present invention has been made in view of such circumstances, and an objective thereof is to provide a base station and a communication control method capable of reliably preventing an overflow of a layer 2 buffer of a mobile station even when the uplink and downlink quality is good.

### Means for Solving the Problem

The first feature of present invention is summarized in that a base station (base station 100) including a layer 2 buffer (layer 2 buffer 101) which is a buffer at a second layer level configured to temporarily store downlink data to be transmitted to a mobile station (mobile station 200A, 200B), the base station including: a scheduling processing unit (scheduling processing unit 107) configured to schedule data stored in the layer 2 buffer on a downlink radio resource; and a buffer retaining amount estimation unit (UE buffer retaining amount estimation unit 105) configured to estimate an amount of buffered data which is retained in a mobile station buffer (layer 2 buffer 210) included in the mobile station and configured to temporarily store downlink data and uplink data, wherein the buffer retaining amount estimation unit estimates the amount of buffered data on the basis of a sum of: downlink data which has been transmitted to the mobile station already but whose acknowledgement has not been received yet; and uplink data which is presumed to be transmitted from the mobile station to the base station after transmission of acknowledgement of uplink data from the base station to the mobile station, and the scheduling processing unit stops scheduling of at least one of downlink data to be transmitted to the mobile station and uplink data to be transmitted from the mobile station if the amount of buffered data estimated by the buffer retaining amount estimation unit exceeds a predetermined threshold.

The second feature of present invention is summarized in that a communication control method using a communication device including a layer 2 buffer which is a buffer at a second layer level configured to temporarily store data to be transmitted to a mobile station, the method including the steps of: scheduling data stored in the layer 2 buffer on a downlink radio resource; and estimating an amount of buffered data which is retained in a mobile station buffer included in the mobile station and configured to temporarily store downlink data and uplink data, wherein in the step of estimating the amount of buffered data, the amount of buffered data is estimated on the basis of a sum of: downlink data which has been transmitted to the mobile station already but whose acknowledgement has not been received yet; and uplink data which is presumed to be transmitted from the mobile station to the base station after transmission of acknowledgement of uplink data from the base station to the mobile station, and in the step of scheduling, scheduling of at least one of downlink data to be transmitted to the mobile station and uplink data to be transmitted from the mobile station is stopped if the amount of buffered data estimated by the buffer retaining amount estimating step exceeds a predetermined threshold.

### BRIEF DESCRIPTION OF THE DRAWINGS

FIG. 1 is an overall schematic configuration diagram of a radio communication system according to an embodiment of the present invention.

FIG. 2 is a functional block diagram of a base station 100 according to the embodiment of the present invention.

FIG. 3 is a diagram for explaining transmission window control and Tx Window Stalling in the base station 100 and a mobile station 200A according to the embodiment of the present invention.

FIG. 4 is a diagram illustrating how data is stored in a layer 2 buffer 210 according to the embodiment of the present invention.

FIG. 5 is a diagram illustrating an operation flow for the base station 100 to execute scheduling of data exchanged with the mobile station 200A.

### MODE FOR CARRYING OUT THE INVENTION

Next, an embodiment of the present invention is described. Note that, in the following description of the drawings, same or similar reference signs denote same or similar elements and portions. In addition, it should be noted that the drawings are schematic and ratios of dimensions and the like are different from actual ones.

Therefore, specific dimensions and the like should be determined in consideration of the following description. Moreover, the drawings also include portions having different dimensional relationships and ratios from each other.

### (1) Overall Schematic Configuration of Radio Communication System

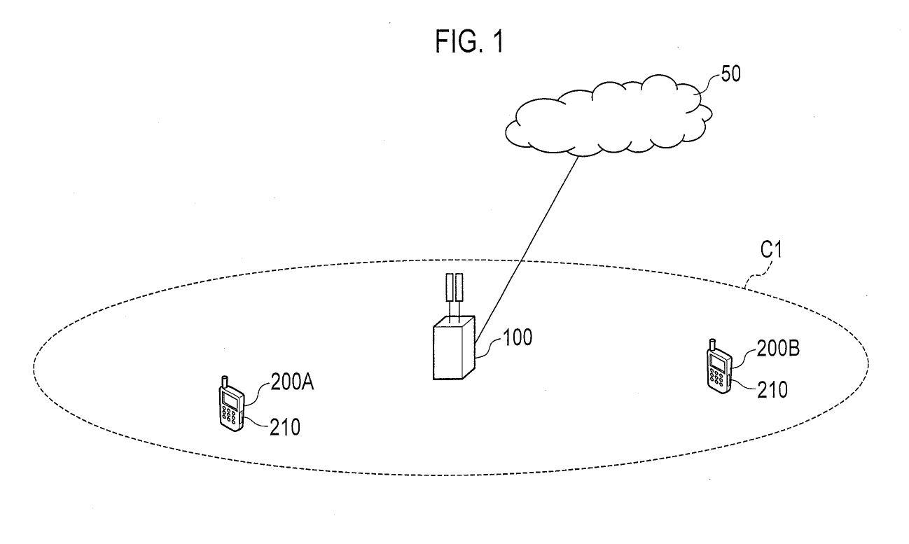

FIG. 1 is an overall schematic configuration diagram of a radio communication system according to the embodiment. As illustrated in FIG. 1, the radio communication system of the embodiment employs the Long Term Evolution (LTE) system, and includes: a core network 50; abase station 100 (eNB); and mobile stations 200A, 200B (UEs).

The base station 100 is connected to the core network 50. The base station 100 forms a cell C1 and performs radio communications with the mobile stations 200A and 200B in compliance with the LTE system. In the embodiment, in particular, the base station 100 includes a layer 2 buffer 101 configured to temporarily store downlink data to be transmitted to the mobile station (and to the mobile station 200B; the same applies in the following).

Meanwhile, the mobile station 200A includes a layer 2 buffer 210 configured to temporarily store downlink data transmitted from the base station 100 and uplink data to be transmitted from the mobile station 200A to the base station 100. In the embodiment, the layer 2 buffer 210 includes a mobile station buffer.

### (2) Functional Block Configuration of Radio Communication System

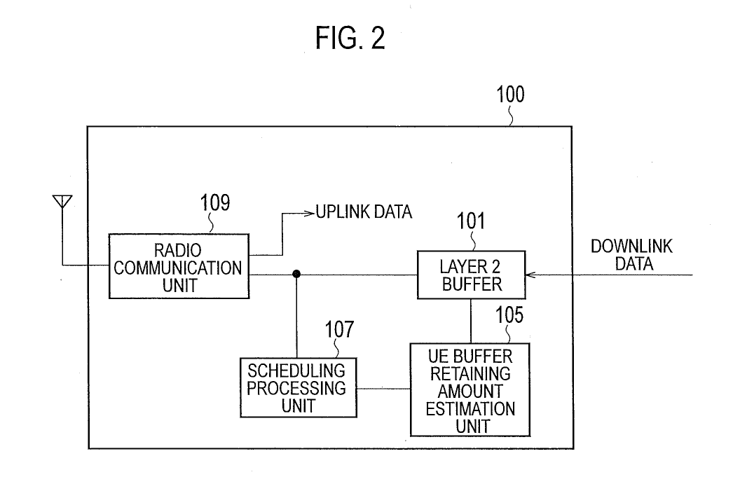

Next, a functional block configuration of the radio communication system according to the embodiment is described. More specifically, a functional block configuration of the base station 100 is described. FIG. 2 is a functional block diagram of the base station 100.

As illustrated in FIG. 2, the base station 100 includes: the layer 2 buffer 101; a UE buffer retaining amount estimation unit 105; a scheduling processing unit 107; and a radio communication unit 109.

The layer 2 buffer 101 temporarily stores data to be transmitted to the mobile stations 200A and 200B via the base station 100. The layer 2 buffer 101 is a second layer level buffer which is shared by multiple mobile stations.

More specifically, the layer 2 buffer 101 temporarily stores an RLC/PDCP SDUs (Service Data Units). The layer 2 buffer 101 (RLC/PDCP buffer) is shared by multiple mobile stations (users) and radio access bearers. The layer 2 buffer 101 is prepared for each cell formed by the base station 100.

The UE buffer retaining amount estimation unit 105 is configured to estimate the amount of buffered data which is retained in the layer 2 buffer 210 of the mobile station 200A. More specifically, the UE buffer retaining amount estimation unit 105 estimates the amount of buffered data on the basis of a sum of: downlink data which has been transmitted to the mobile station 200A already but whose acknowledgement (ACK) has not been received yet; and uplink data which is presumed to be transmitted from the mobile station 200A to the base station 100 after transmission of acknowledgement of uplink data from the base station 100 to the mobile station 200A.

A method of estimating the amount of buffered data in the layer 2 buffer 210 performed by the UE buffer retaining amount estimation unit 105 is described in more detail below. The UE buffer retaining amount estimation unit 105 estimates the amount of buffered data in the layer 2 buffer 210 (Estimated_UE_L2_buffered_data) on the basis of a value obtained by adding the following data. Note that a mobile station (user) being a destination of downlink data stored (retained) in the layer 2 buffer 101 can be identified by checking a TEID (Tunnel Endpoint Identifier) which is a transmission destination identifier assigned to a SDU (see 3GPP TS29.060).
Downlink data (DL data) which the base station 100 has transmitted to the mobile station 200A already but for which the base station 100 has not acknowledged RLC ACK from the mobile station 200A yet
Uplink data (UL data) which is presumed to be transmitted by the mobile station 200A after the time point when the base station 100 transmits RLC ACK last

The UE buffer retaining amount estimation unit 105 deems that there is no new data in all logical channels established with the mobile station 200A if {Estimated_UE_L2_buffered_data≧size of layer 2 buffer 210 (Total L2 buffer size)} is satisfied. With the above operation, in the case where it is predicted that an overflow of the layer 2 buffer 210 has occurred or that an overflow of the layer 2 buffer 210 will occur, new scheduling of at least one of downlink data to the mobile station 200A and uplink data from the mobile station 200A is stopped.

The UE buffer retaining amount estimation unit 105 estimates the amount of downlink data on the basis of an average size of downlink PDUs transmitted via radio access bearers using RLC-AM (Acknowledged Mode) and the number of transmitted PDUs. Likewise, the UE buffer retaining amount estimation unit 105 estimates the amount of uplink data on the basis of an average size of uplink PDUs transmitted from the mobile station via radio access bearers using RLC-AM and the number of received PDUs.

More specifically, of the downlink data which the base station 100 has transmitted already but for which the base station 100 has not acknowledged RLC ACK from the mobile station 200A yet, the UE buffer retaining amount estimation unit 105 calculates downlink data transmitted via bearers using RLC-AM by use of the following mathematical formula.

$${\sum }_{RLC - AM}^{ } ( {Size}_{DL\_PDU \_average} \times {N}_{DL\_PDU} ) \vert \qquad [ Mathematical Formula 1 ]$$

Here, Size_{DL}_{_{—}}_{PDU}_{_{—}}_{average} indicates an average DL RLC PDU size, and can be obtained from an average value of sizes of all transmitted DL RLC PDUs and from an average RLC PDU size of DL RLC PDUs whose RLC ACK from the mobile station 200A has not been acknowledged yet. N_{DL}_{_{—}}_{PDU} indicates the number of DL RLC PDUs whose RLC ACK from the mobile station 200A has not been acknowledged yet.

In addition, of the uplink data which is presumed to be transmitted by the mobile station 200A after the time point when the base station 100 transmits RLC ACK last, the UE buffer retaining amount estimation unit 105 calculates uplink data transmitted via bearers using RLC-AM by use of the following mathematical formula.

$${\sum }_{RLC - AM}^{ } ( {Size}_{UL\_PDU \_average} \times {N}_{UL\_PDU} ) \qquad [ Mathematical Formula 2 ]$$

Here, Size_{UL}_{_{—}}_{PDU}_{_{—}}_{average} indicates an average UL RLC PDU size, and can be obtained from an average value of sizes of all UL RLC PDUs received by the base station 100 and from an average RLC PDU size of UL RLC PDUs which are presumed to be transmitted by the mobile station 200A after the time point when the base station 100 transmits RLC ACK last. N_{UL}_{_{—}}_{PDU} indicates the number of UL RLC PDUs which are presumed to be transmitted by the mobile station 200A after the time point when the base station 100 transmits RLC ACK last.

The UE buffer retaining amount estimation unit 105 may add the amount of downlink data (the amount of additional downlink data) transmitted via radio access bearers using RLC-UM (Unacknowledged Mode), to the amount of downlink data transmitted via radio access bearers using RLC-AM which is calculated from the above mathematical formula. Likewise, the UE buffer retaining amount estimation unit 105 may add the amount of uplink data (the amount of additional uplink data) received from the mobile station 200A via radio access bearers using RLC-UM, to the amount of uplink data received via radio access bearers using RLC-AM which is calculated from the above mathematical formula.

Note that, when estimating the amount of uplink data received from the mobile station 200A via radio access bearers using RLC-AM, the UE buffer retaining amount estimation unit 105 is not able to know exactly how much uplink data does the mobile station 200A actually transmit (how much uplink data does the mobile station 200A wait for acknowledgement (ACK)) at a certain time point. To handle this, the UE buffer retaining amount estimation unit 105 estimates this from sequence numbers (SNs) of RLC PDUs which the base station 100 has received already at the time point when the estimation is made. Since a reception side of the RLC layer manages the reception condition by means of status variables, the UE buffer retaining amount estimation unit 105 estimates the amount of uplink data which the mobile station 200A has transmitted already (for which the mobile station 200A waits for acknowledgement (ACK)), by using a given variable among the status variables.

More specifically, the UE buffer retaining amount estimation unit 105 estimates the amount of data retained in uplink from the following mathematical formula.

UL buffered data amount=Size_{UL}_{_{—}}_{PDU}_{_{—}}_{average}×(VR(H)−Last_ACKed)

Here, Last_ACKed indicates a SN of an RLC PDU which reports ACK last. VR(H) is obtained by adding +1 to the largest SN of the SNs of the received RLC PDUs. In addition, since N_{UL}_{_{—}}_{PDU} can be represented by=VR(H)−Last_ACKed, Size_{UL}_{_{—}}_{PDU}_{_{—}}_{average} can be obtained by the following mathematical formula.

$${Size}_{UL\_PDU \_average} = \frac{{Size}_{UL\_PDU \_total}}{{N}_{UL\_PDU}} \vert \qquad [ Mathematical Formula 3 ]$$

Besides, the UE buffer retaining amount estimation unit 105 can update Last ACKed as follows.
At the time of radio access bearer establishment: set to 0 (zero)
At the time of status report transmission
   When no NACK is included in status report: set to reported ACK_SN
   When NACK is included in status report: set to first NACK_SN

Here, in the case where any of SNs of RLC PDUs not having been received is reported in the status report as NACK_SN, setting the earliest (smallest) SN is preferable.

Besides, the UE buffer retaining amount estimation unit 105 can update Size_{UL}_{_{—}}_{PDU}_{_{—}}ₜₒₜₐₗ (the amount of received uplink data) as follows.
At the time of radio access bearer establishment: set to 0 (zero)
At the time of UL AMD PDU reception:

Size_{UL}_{_{—}}_{PDU}_{_{—}}ₜₒₜₐₗ=Size_{UL}_{_{—}}_{PDU}_{_{—}}ₜₒₜₐₗ+(size of received AMD PDU)
At the time of Last_Acked update:

$${Size}_{UL\_PDU \_total} = {Size}_{UL\_PDU \_total} \times \frac{VR ( H ) - {Last\_ ACKed}_{new}}{VR ( H ) - {Last\_ ACKed}_{old}} \qquad [ Mathematical Formula 4 ]$$

Meanwhile, no status report (acknowledgement) is transmitted from a reception side in the RLC layer regarding the amount of uplink data (the amount of additional uplink data, e.g., voice packets) received from the mobile station 200A via radio access bearers using RLC-UM. For this reason, the UE buffer retaining amount estimation unit 105 estimates the amount of buffered data on the assumption that a given amount of data is retained at all times.

For example, the UE buffer retaining amount estimation unit 105 deems that, for every radio access bearer using RLC-UM, the following amount of data is uniformly retained in the layer 2 buffer 210 of each mobile station (UE).

The first one is a total data size of RLC-PDUs which are being transmitted by each UE (UM_transmit_buffer_size). UM_transmit_buffer_size can be obtained by multiplying a voice packet size by the number of voice packets each mobile station is capable of transmitting concurrently. The second one is a total data size of RLC-PDUs of each mobile station waiting for ordering control (UM_reordering_buffer_size). UM_reordering_buffer_size can be obtained by multiplying a voice packet size by the number of voice packets which are presumed to be concurrently received by each mobile station.

The scheduling processing unit 107 is configured to schedule downlink data stored in the layer 2 buffer 101 on downlink radio resources. More specifically, the scheduling processing unit 107 stops scheduling of down link data to be transmitted to the mobile station 200A if the amount of buffered data retained in the layer 2 buffer 210 of the mobile station 200A, which is estimated by the UE buffer retaining amount estimation unit 105, exceeds a predetermined threshold. The scheduling processing unit 107 may also stop scheduling of uplink data to be transmitted from the mobile station 200A if the amount of buffered data exceeds the predetermined threshold.

In addition, if downlink data or uplink data being a scheduling stop target is retransmission data of Hybrid ARQ, the scheduling processing unit 107 may schedule the downlink data or the uplink data on radio resources.

Likewise, if downlink data or uplink data being a scheduling stop target is retransmission data in the RLC layer, the scheduling processing unit 107 schedules the downlink data or the uplink data on radio resources. In other words, the scheduling processing unit 107 does not need to stop scheduling of retransmission data of Hybrid ARQ or retransmission data in the RLC layer on radio resources.

The radio communication unit 109 is configured to perform radio communications with the mobile station 200A in accordance with the LTE system. In the embodiment, in particular, the radio communication unit 109 transmits downlink data (PDUs) outputted from the layer 2 buffer 101 to the mobile station 200A by means of radio resources assigned by the scheduling processing unit 107.

The radio communication unit 109 also receives radio signals transmitted from the mobile station 200A, and outputs uplink data (PDUs) made by executing demodulation processing and decoding processing thereon.

### (3) Operation of Radio Communication System

Next, an operation of the radio communication system according to the embodiment is described. Specifically, an operation for the base station 100 to execute scheduling of data exchanged with the mobile station 200A.

(3.1) Transmission Window Control

First, a description is given of transmission window control and Tx Window Stalling on a transmission side (for example, the base station 100) and on a reception side (for example, the mobile station 200A) which constitute the premises in the embodiment.

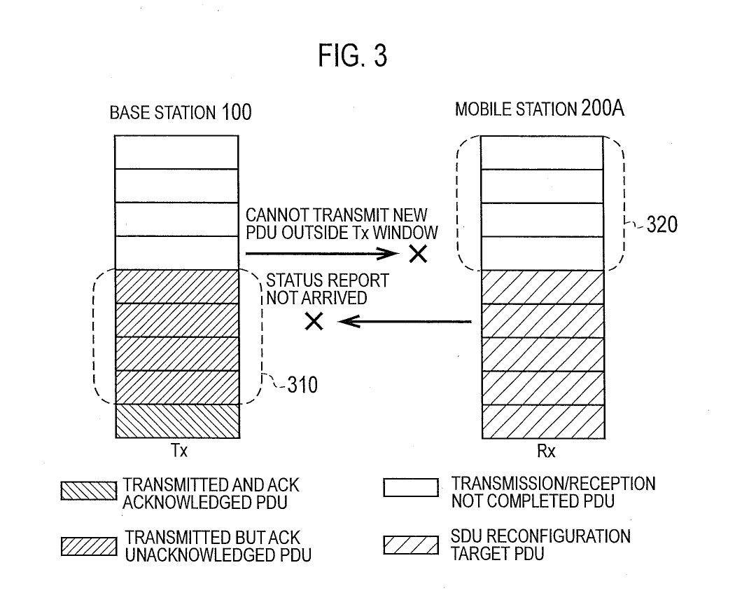

FIG. 3 is a diagram for explaining transmission window control and Tx Window Stalling in the base station 100 and the mobile station 200A. As illustrated in FIG. 3, in the embodiment, the reception-side mobile station 200A transmits status reports to the base station 100, and thereby a Tx Window 310 is slid sequentially while PDUs whose ACK has not been acknowledged yet are retransmitted and PDUs having been received twice or more are discarded. Likewise, an Rx Window 320 is also slid sequentially in response to receipt of PDUs.

As illustrated in FIG. 3, if the base station 100 cannot receive status reports from the mobile station 200A and therefore cannot update the Tx Window 310, the base station 100 cannot transmit new PDUs to the mobile station 200A, which deteriorates throughput. In order to avoid Tx Window Stalling, it is necessary to feed back status reports to the base station 100 at a proper frequency.

The RLC layer of the base station 100 manages the Tx Window 310, and if Tx Window Stalling occurs, stops scheduling of new downlink data via the corresponding radio access bearer.

In the embodiment, it is deemed that Tx Window Stalling occurs if an overflow of the layer 2 buffer 210 (RLC/PDCP buffer) of the mobile station 200A occurs, and new scheduling of downlink data and uplink data is stopped. Note that new scheduling of uplink data does not necessarily have to be stopped.

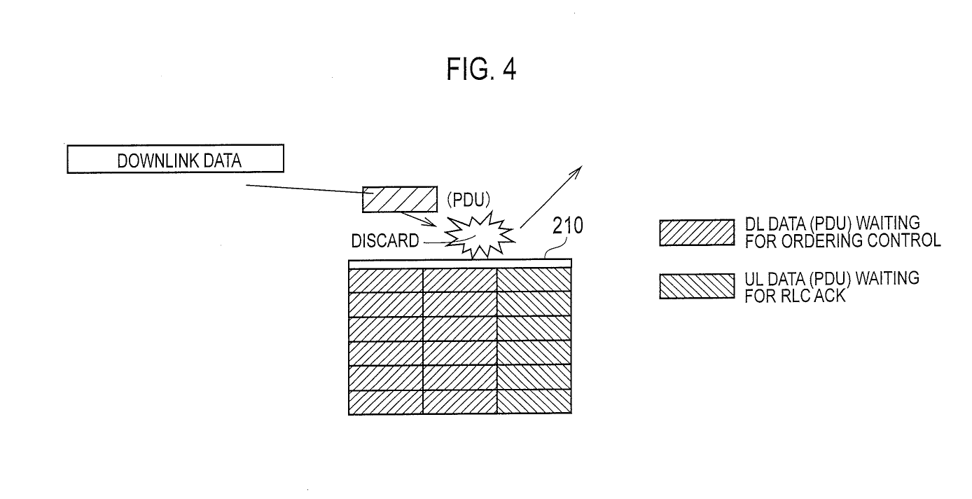

FIG. 4 is a diagram illustrating how data is stored in the layer 2 buffer 210. As illustrated in FIG. 4, the capacity of the layer 2 buffer 210 is limited, and hence once an overflow occurs, data (PDUs) arriving at the buffer after the overflow occurs is discarded. Data stored in the layer 2 buffer 210 includes the following two types.
Downlink data (DL data) waiting for ordering control (reordering)
Uplink data (UL data) whose RLC ACK from the base station 100 has not been acknowledged yet

In particular, such an overflow is likely to occur when an average transport block size (the number of bits transmitted per TTI) is large.

As described above, the base station 100 according to the embodiment estimates the amount of buffered data retained in the layer 2 buffer 210, and if the amount of buffered data exceeds a predetermined threshold, the base station 100 deems that Tx Window Stalling occurs, and stops new scheduling of downlink data and uplink data.

(3.2) Operation Flow of Base Station 100

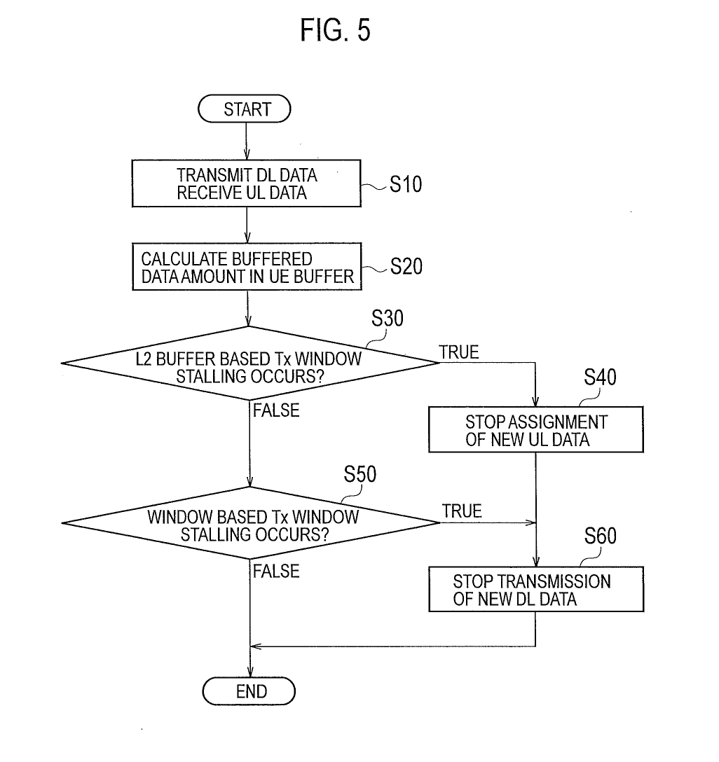

FIG. 5 illustrates an operation flow for the base station 100 to execute scheduling of data exchanged with the mobile station 200A.

As illustrated in FIG. 5, the base station 100 executes processing associated with transmission of downlink data or reception of uplink data (S10), and calculates the amount of data (the amount of buffered data) presumed to be retained in the layer 2 buffer 210 of the mobile station 200A (UE) (S20).

Next, the base station 100 guesses whether or not an overflow of the layer 2 buffer 210 will occur on the basis of the calculated amount of buffered data (S30). More specifically, the base station 100 judges whether or not Tx Window Stalling associated with the guess that the overflow of the layer 2 buffer 210 will occur (which is called L2 buffer based Tx Window Stalling) occurs.

If L2 buffer based Tx Window Stalling occurs, the base station 100 stops the assignment of new uplink data (S40). Moreover, if L2 buffer based Tx Window Stalling occurs, the base station 100 also stops transmission of new downlink data (S60).

On the other hand, if no L2 buffer based Tx Window Stalling occurs, the base station 100 judges whether or not ordinary Tx Window Stalling (which is called Window based Tx Window Stalling) occurs (S50). Here, as described above, Window based Tx Window Stalling indicates a state where the base station 100 cannot receive status reports from the mobile station 200A and therefore cannot update the Tx Window 310 (see FIG. 3). If Window based Tx Window Stalling occurs, the base station 100 stops transmission of new downlink data (S60).

Note that, in the flow illustrated in FIG. 5, the judgment on L2 buffer based Tx Window Stalling (S30) and the judgment on Window based Tx Window Stalling (S50) may be performed in a reverse order.

### (4) Operation and Effect

The base station 100 estimates the amount of buffered data on the basis of a sum of: downlink data which the base station 100 has transmitted to the mobile station 200A already but for which the base station 100 has not received acknowledgement yet; and uplink data which is presumed to be transmitted from the mobile station 200A to the base station 100 after transmission of acknowledgement of uplink data from the base station 100 to the mobile station 200A. Further, if the estimated amount of buffered data exceeds a predetermined threshold, the base station 100 stops scheduling of downlink data to be transmitted to the mobile station 200A and uplink data to be transmitted from the mobile station 200A.

Accordingly, even if an overflow of the layer 2 buffer 210 of the mobile station 200A is expected to occur, the overflow of the layer 2 buffer 210 can be reliably prevented by stopping the scheduling of the downlink data and the uplink data. In particular, even when the quality of uplink and downlink between the base station 100 and the mobile station 200A is good and a large amount of data arrives at the mobile station 200A in a short period along with an increase in effective communication speed, an overflow of the layer 2 buffer 210 can be reliably prevented.

In the embodiment, although the amount of downlink data and the amount of uplink data are estimated on the basis of data transmitted via radio access bearers using RLC-AM, data transmitted via radio access bearers using RLC-UM may be added to the amount of downlink data and the amount of uplink data above. Thereby, the amount of buffered data in the layer 2 buffer 210 can be estimated more accurately.

In the embodiment, if downlink data or uplink data being a scheduling stop target is retransmission data of Hybrid ARQ, or if downlink data or uplink data being a scheduling stop target is retransmission data in the RLC layer, the downlink data or the uplink data is scheduled on radio resources, i.e., the downlink data or the uplink data is excluded from the scheduling stop target. In this way, data which would be largely affected if its scheduling is stopped is transmitted promptly, which effectively suppresses deterioration of throughput.

### (5) Other Embodiment

As described above, the details of the present invention have been disclosed by using the embodiment of the present invention. However, it should not be understood that the description and drawings which constitute part of this disclosure limit the present invention. From this disclosure, various alternative embodiments will be easily found by those skilled in the art.

For example, in the above embodiment, when it is estimated that an overflow of the layer 2 buffer 210 will occur, the assignment of or transmission of downlink data or uplink data is stopped by using the existing function of stopping data scheduling when Tx Window Stalling occurs. However, such function of stopping data scheduling when Tx Window Stalling occurs does not necessarily have to be used, and a separate independent function may be provided to stop data scheduling.

As described above, the present invention naturally includes various embodiments which are not described herein. Accordingly, the technical scope of the present invention should be determined only by the matters to define the invention in the scope of claims regarded as appropriate based on the description.

Note that the entire content of Japanese Patent Application No. 2011-222034 (filed on Oct. 6, 2011) is incorporated herein by reference.

### INDUSTRIAL APPLICABILITY

According to the aspects of the present invention, it is possible to provide a base station and a communication control method capable of reliably preventing an overflow of a layer 2 buffer of a mobile station even when the downlink quality is good.

### EXPLANATION OF THE REFERENCE NUMERALS

50 core network

100 base station

101 layer 2 buffer

105 UE buffer retaining amount estimation unit

107 scheduling processing unit

109 radio communication unit

200A, 200B mobile station

210 layer 2 buffer

310 Tx Window

320 Rx Window

C1 cell

1. Abase station including a layer 2 buffer which is a buffer at a second layer level configured to temporarily store downlink data to be transmitted to a mobile station, the base station comprising:
a scheduling processing unit configured to schedule data stored in the layer 2 buffer on a downlink radio resource; and
a buffer retaining amount estimation unit configured to estimate an amount of buffered data which is retained in a mobile station buffer included in the mobile station and configured to temporarily store downlink data and uplink data, wherein
the buffer retaining amount estimation unit estimates the amount of buffered data on the basis of a sum of: downlink data which has been transmitted to the mobile station already but whose acknowledgement has not been received yet; and uplink data which is presumed to be transmitted from the mobile station to the base station after transmission of acknowledgement of uplink data from the base station to the mobile station, and
the scheduling processing unit stops scheduling of at least one of downlink data to be transmitted to the mobile station and uplink data to be transmitted from the mobile station if the amount of buffered data estimated by the buffer retaining amount estimation unit exceeds a predetermined threshold.

2. The base station according to claim 1, wherein the buffer retaining amount estimation unit
estimates an amount of downlink data on the basis of an average size of downlink PDUs transmitted via a radio access bearer using RLC-AM and the number of transmitted PDUs, and
estimates an amount of uplink data on the basis of an average size of uplink PDUs transmitted from the mobile station via a radio access bearer using RLC-AM and the number of received PDUs.

3. The base station according to claim 2, wherein the buffer retaining amount estimation unit
adds an amount of additional downlink data transmitted via a radio access bearer using RLC-UM, to the amount of downlink data, and
adds an amount of additional uplink data received via a radio access bearer using RLC-UM, to the amount of uplink data.

4. The base station according to claim 1, wherein, if downlink data or uplink data being a scheduling stop target is retransmission data of Hybrid ARQ, or if downlink data or uplink data being a scheduling stop target is retransmission data in an RLC layer, the scheduling processing unit schedules the downlink data or the uplink data on a radio resource.

5. A communication control method using a communication device including a layer 2 buffer which is a buffer at a second layer level configured to temporarily store data to be transmitted to a mobile station, the method comprising the steps of:
scheduling data stored in the layer 2 buffer on a downlink radio resource; and
estimating an amount of buffered data which is retained in a mobile station buffer included in the mobile station and configured to temporarily store downlink data and uplink data, wherein
in the step of estimating the amount of buffered data, the amount of buffered data is estimated on the basis of a sum of: downlink data which has been transmitted to the mobile station already but whose acknowledgement has not been received yet; and uplink data which is presumed to be transmitted from the mobile station to the base station after transmission of acknowledgement of uplink data from the base station to the mobile station, and
in the step of scheduling, scheduling of at least one of downlink data to be transmitted to the mobile station and uplink data to be transmitted from the mobile station is stopped if the amount of buffered data estimated by the buffer retaining amount estimating step exceeds a predetermined threshold.
